(19) United States
(12) Patent Application Publication
(10) Pub. No.: US 2011/0179659 A1
(43) Pub. Date: Jul. 28, 2011

(54) METHOD OF MEASURING AN INVOLUTE GEAR TOOTH PROFILE

(76) Inventor: Masatoshi YUZAKI, Tokyo (JP)

(21) Appl. No.: 13/081,596

(22) Filed: Apr. 7, 2011

(30) Foreign Application Priority Data
Apr. 29, 2009 (JP) PCT/JP2009/058599

(51) Int. Cl. G01B 3/50

(52) U.S. Cl. 33/501.9

(57) ABSTRACT

Provided is a new method of measuring involute gear tooth profile that differs from the base circle method and enables measurement of super-large gears without increasing the size of the tooth profile measuring machine and without increasing shift of the machine center of gravity. Measurement is performed during simultaneous θ axis control for rotating a test gear around the gear axis, X axis control for reciprocating a probe toward and away from the gear axis, and Y axis control for reciprocating the probe perpendicular to the X axis, thereby moving the probe along a line of action.

### TECHNICAL FIELD

This invention relates to a gear tooth profile measurement method for measuring the tooth profile of an involute gear (hereinafter sometimes called simply a “gear”), particularly to a new method of measuring gear tooth profile that differs from the base plate method, adjustable base plate method, and computer numerical control (CNC) method, which are the methods generally utilized for tooth profile measurement.

### BACKGROUND ART

Gear tooth profile measurement is usually done using the base plate method, adjustable base plate method, or computer numerical control (CNC) method (all of which are referred to as base circle methods in the following). The measurement principle of a base circle method is to bring a straight edge and a base plate into rolling contact while using a probe carried on the straight edge to trace a tooth of the test gear mounted on the base plate.

Among known tooth profile measuring machines utilizing the base circle method, Japanese Unexamined Patent Publication No. 9-5009 (particularly para. 0016 and FIGS. 3 and 5), for example, teaches a machine for measuring helical gear tooth profile that is equipped with a rotating mechanism for rotating the test gear by a pre-controlled amount around the gear axis (termed the “center axis” in the Publication) and a linear drive mechanism for simultaneously moving a probe by a pre-controlled amount in at least two directions among a total of three directions comprising a vertical direction parallel to the gear axis (Z direction) and two orthogonal directions (X and Y directions) within a plane perpendicular to the gear axis, thereby providing a machine capable of directly detecting tooth profile shape error along a simultaneous contact line or in the meshing direction.

Among known tooth profile measuring methods not utilizing the base circle method, Japanese Unexamined Patent Publication No. 9-264738 (particularly paras. [0009 and [0011 and FIG. 6), for example, teaches a method, called the “trace control method,” that moves a probe along the X axis, rotates the test gear around the gear axis (termed the “A axis” in the Publication) so that the probe automatically moves in the tooth profile direction while maintaining contact with the tooth face of the test gear, thereby enabling tooth profile measurement without providing linear scales on the respective X, Y, Z and θ axes as required in a gear tooth profile machine utilizing the base circle system.

### DISCLOSURE OF THE INVENTION

### Problem to be Overcome by the Invention

In the aforesaid base circle method, measurement is conducted while the probe mounted on the straight edge corresponding to the Y axis is being moved tangential to the base circle of the test gear in parallel with the Y axis and in the direction away from the center of the Y axis. Therefore, when it is attempted to measure the tooth profile of a super-large gear of a diameter of, for example, greater than 2 m, the measureable area becomes distant from the center of the Y axis. Of particular note is that when measurement of the left and right tooth faces is to be performed without re-attaching the gear, the Y axis of the measuring machine must be elongated, which increases the measuring machine size.

Moreover, in order to measure the tooth profile of a super-large gear using the aforesaid base circle method, it is necessary to move the column carrying the probe to a position far away from the center of the Y axis, so that the measurement accuracy is degraded by the resulting shift in the center of gravity of the measuring machine.

In addition, inner gear measurement by the base circle method is performed using a special probe that enables the probe to contact the inner tooth faces even from a position distant from the center of the Y axis. However, measurement of the left and right tooth faces without re-attaching the gear requires re-attachment of the special probe, which is a troublesome operation.

The measuring machine according to the aforesaid Publication No. 9-5009 has these problems because it adopts the base circle method

On the other hand, in the measuring method according to Publication No. 9-264738, the angle of contact of the probe with the tooth face of the test gear varies as the probe moves in the tooth profile direction while maintaining contact with the tooth face of the test gear. This makes a contact angle correction calculation necessary, but since the desired accuracy cannot be obtained even by conducting the correction calculation, this measuring method (trace control method) is seldom used nowadays.

The object of this invention is therefore to overcome the issues experienced in using the base circle method by providing a new-type method of measuring gear tooth profile that differs from the generally utilized base circle method.

### Means for Solving the Problem

In order to solve the aforesaid problems, a first aspect of the invention provides a method of measuring involute gear tooth profile wherein measurement is performed during simultaneous θ axis control for rotating a test gear around the gear axis, X axis control for reciprocating a probe toward and away from the gear axis, and Y axis control for reciprocating the probe perpendicular to the X axis.

In its second aspect, this invention provides a method of measuring involute gear tooth profile wherein measurement is performed while moving the probe along the line of action.

### Effect of the Invention

In measurement by the base circle method, the measurement is performed during simultaneous two-axis (Y axis and θ axis) control. In contrast, in the method according to the first aspect of the invention, the measurement is performed during simultaneous three-axis (X, Y and θ axis) control. The distance that the probe moves along the Y axis can therefore be shortened in comparison with that in the measurement by the base circle method. Since the Y axis can therefore be made shorter than in a measuring machine utilizing the base circle method, the size of the measuring machine can be reduced. In addition, the travel distance of the column carrying the probe can be shortened, so that movement of the measuring machine center of gravity can be reduced to minimize loss of measurement accuracy. Further, the shorter travel distance of the probe along the Y axis shortens the measurement time. Moreover, the fact that the control of the X and Y axes is simultaneous makes it possible to view X and Y as spatial coordinates, so that the travel accuracy required is not as high as that in the base circle method.

Measurement by the base circle method is performed while moving the probe tangential to the base circle of the test gear in parallel with the Y axis and in the direction away from the center of the Y axis. In contrast, in the method according to the second aspect of the invention, the measurement is performed while moving the probe along the line of action. The measurement can therefore be performed while moving the probe along the center region of the Y axis. As a result, the right and left tooth faces can be measured by reciprocating the probe over substantially the same range of the center region of the Y axis.

In the method according to the second aspect of the invention, the measurement can be performed while moving the probe in the center region of the Y axis. As a result, an inner gear can be measured without using a special probe, and the left and right tooth faces can be measured without re-attaching the probe.

Moreover, since the angle of contact of the probe with the tooth face of the test gear is constant according to the second aspect of the invention, no contact angle correction calculation is necessary.

### BRIEF DESCRIPTION OF THE DRAWINGS

FIG. 1 is a schematic perspective view of a tooth profile measuring machine.

FIG. 2 is a set of plan views showing the movement of the probe in the method of measuring gear tooth profile of this invention, wherein FIG. 2(a) is a view showing the state at the start of measurement, FIG. 2(b) is a view showing the state during measurement, and FIG. 2(c) is a view showing the state at the end of measurement.

FIG. 3 is a set of views illustrating the measurement principle of the method of measuring gear tooth profile of this invention, wherein FIG. 3(a) a view showing the case of measuring the right tooth face of an outer gear, and FIG. 3(b) is a view showing the case of measuring the left tooth face of the outer gear.

FIG. 4 is a view illustrating the principle of gear tooth profile measurement utilizing the base circle method, showing the case of measuring an outer gear.

FIG. 5 is a set of views illustrating the measurement principle of the method of measuring gear tooth profile of this invention, wherein FIG. 5(a) is a view showing the case of measuring the right tooth face of an inner gear, and FIG. 5(b) is a view showing the case of measuring the left tooth face of the inner gear.

FIG. 6 is a view illustrating the principle of gear tooth profile measurement utilizing the base circle method, showing the case of measuring an inner gear.

### MODES FOR WORKING THE INVENTION

The basic considerations that led to the creation of this invention will be briefly explained first. Focusing on the need felt for measurement of the tooth profiles of even super-large gears such as those used at hydroelectric power stations, the inventor experimented with super-large gear measurement using the base circle method. However, he concluded that measurement of super-large gear tooth profile by this method would be difficult owing to the need to develop a large-scale measuring machine and the fact that even if such a large measuring machine were developed, the measurement accuracy would be poor due to shift of the measuring machine center of gravity.

The base circle method was established for measuring the tooth profile of involute gears and it was universally considered that measurement had to be performed while moving the probe parallel to the Y axis, that is, that accurate measurement could not be achieved without fixing the X axis during measurement. Against this backdrop, the inventor noted that the teeth of an involute gear are cut under synchronized rotation of the hob cutter and the gear being hobbed, with the involute tooth profile being produced as the hob cutting point moves along the line of action of the gear. From this observation, the inventor realized that tooth profile can be measured by moving the probe along the line of action and achieved this invention as a result. Specifically, this invention disproves the commonly held belief that measurement must be performed under simultaneously two-axis (Y and θ axis) control for performing measurement while moving the probe parallel to the Y axis and realizes a new-type measurement method that conducts simultaneous three-axis (X, Y and θ axis) control to move the probe along the line of action.

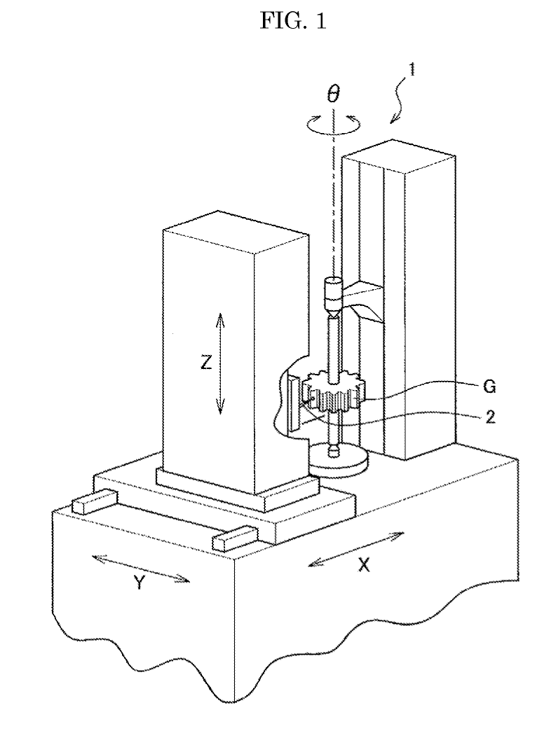

An embodiment of the invention will now be explained in detail with reference to the drawings. FIG. 1 is a schematic perspective view of a tooth profile measuring machine for explaining the invention method of measuring gear tooth profile.

As shown in FIG. 1, an involute gear tooth profile measuring machine 1 comprises a θ axis around which a test gear G (hereinafter sometimes called simply “gear”) is rotated about the gear axis, an X axis along which a probe 2 is reciprocated toward and away from the gear axis, a Y axis along which the probe 2 is reciprocated perpendicular to the X axis, and a Z axis along which the probe 2 is reciprocated in a direction parallel to the θ axis (i.e., vertically). A tooth profile measuring machine 1 having at least these four (X, Y, Z and θ) axes is sufficient. If it is a CNC tooth profile measuring machine, for example, the gear tooth profile measuring method of this invention can be implemented by conducting four-axis control for moving the probe 2 along the line of action.

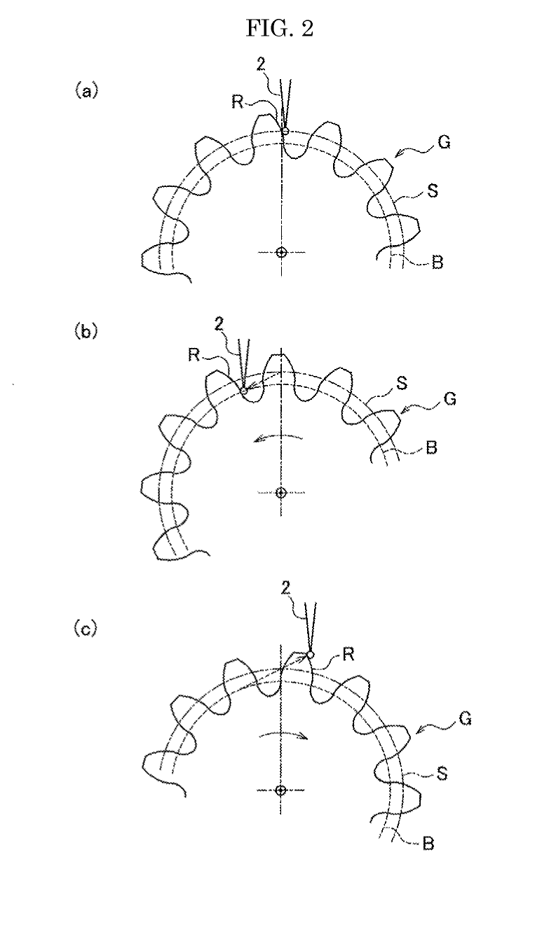

FIG. 2 is a set of plan views showing the movement of the probe in the method of measuring gear tooth profile of this invention. FIG. 2(a) shows the state at the start of measurement, FIG. 2(b) shows the state during measurement, and FIG. 2(c) shows the state at the end of measurement. In the figures, B indicates the base circle and S indicates the reference circle.

As shown in FIG. 2(a), in its state at the start of measurement the probe 2 is positioned on the line of action at the point of intersection with the reference circle S. As shown in FIG. 2(b), as the probe 2 is driven simultaneously along the X axis and Y axis (not shown; see FIG. 1) synchronously with counterclockwise rotation of the gear G around the θ axis (see FIG. 1), the probe 2 moves along the line of action indicated by the arrow toward the dedendum side to trace the right tooth face R of the gear G. Then, as shown in FIG. 2(c), as the probe 2 is driven simultaneously along the X axis and Y axis (not shown) synchronously with clockwise rotation of the gear G around the θ axis (see FIG. 1), the probe 2 moves along the line of action indicated by the arrow toward the addendum side to trace the right tooth face R of the gear G. Although the case where the probe 2 located on the line of action starts measurement from the point of intersection with the reference circle S is explained here, measurement can be started from any point on the line of action. Moreover, while the probe 2 preferably moves along the line of action, it is not necessarily required to move along the line of action, provided that the actual line of movement is corrected to the line of action.

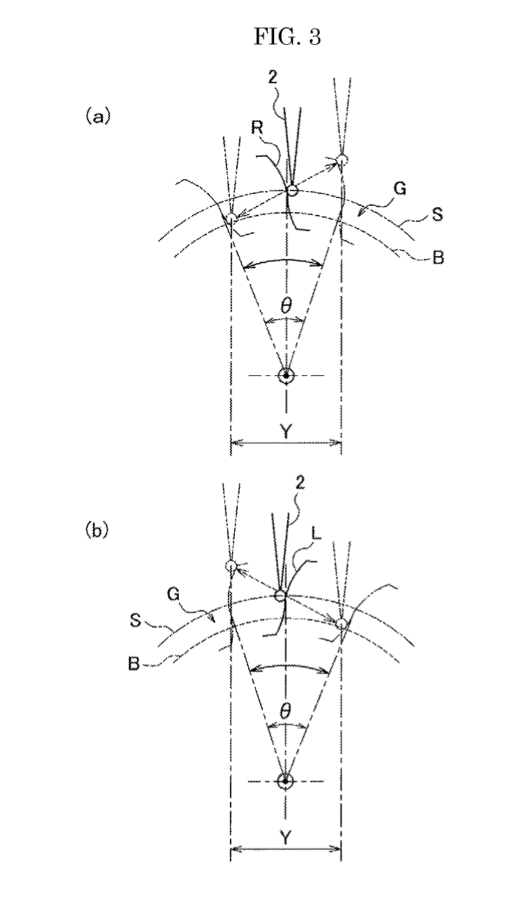

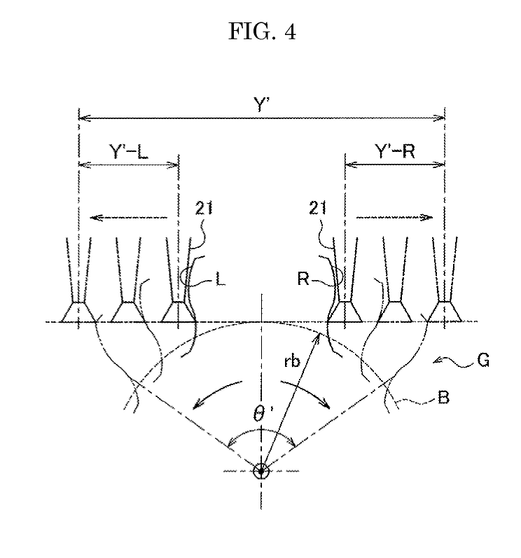

FIG. 3 is a set of views illustrating the measurement principle of the method of measuring gear tooth profile of this invention. FIG. 3(a) shows the case of measuring the right tooth face of an outer gear. FIG. 3(b) shows the case of measuring the left tooth face of the outer gear. FIG. 4 is a view illustrating the principle of gear tooth profile measurement utilizing the base circle method, showing the case of measuring an outer gear. In FIG. 4, B indicates the base circle and S indicates the reference circle.

The measurement principle of the invention gear tooth profile measurement method is to rotate the test gear G while moving the probe 2 along the line of action to trace the test gear G with the probe 2. As shown in FIG. 3(a), when the right tooth face R of the outer gear G is measured by the invention tooth profile measuring method, the probe 2 located on the line of action on the right tooth face R as indicated by a solid line is moved from the point of intersection with the reference circle S synchronously with counterclockwise rotation of the outer gear G, as shown by a two-dot chain line, along the line of action indicated by the arrow toward the dedendum side to trace the right tooth face R of the gear G. Next, the probe 2 is moved synchronously with clockwise rotation of the outer gear G along the line of action indicated by the arrow toward the addendum side to trace the right tooth face R of the gear G. The locus of the probe 2 at this time describes a true involute curve.

As shown in FIG. 3(b), when the left tooth face L of the outer gear G is measured by the invention tooth profile measuring method, the probe 2 located on the line of action on the left tooth face L as indicated by a solid line is moved from the point of intersection with the reference circle S synchronously with clockwise rotation of the outer gear G, as shown by a two-dot chain line, along the line of action indicated by the arrow toward the dedendum side to trace the left tooth face L of the gear G. Next, the probe 2 is moved synchronously with counterclockwise rotation of the outer gear G along the line of action indicated by the arrow toward the addendum side to trace the left tooth face L of the gear G. The locus of the probe 2 at this time describes a true involute curve.

In contrast, the measurement principle of the base circle method is to turn the test gear G while moving a probe 21 tangentially to the base circle B to trace the test gear G with the probe 21. As shown in FIG. 4, when the right tooth face R of an outer gear G is measured by the base circle tooth profile measuring method, the probe 21 located on the right tooth face R as indicated by a solid line is moved from the point of intersection with a tangent to the base circle B synchronously with clockwise rotation of the outer gear G, as shown by a two-dot chain line, tangentially to the base circle B as indicated by a dotted line, which is to say that the probe 21 moves parallel to the Y axis away from the center line to trace the right tooth face R. The locus of the probe 21 at this time describes a true involute curve.

Further, as shown in FIG. 4, when the left tooth face L of the outer gear G is measured by the base circle tooth profile measuring method, the probe 21 located on the left tooth face L as indicated by a solid line is moved from the point of intersection with a tangent to the base circle B synchronously with counterclockwise rotation of the outer gear G, as shown by a two-dot chain line, tangentially to the base circle B as indicated by a dotted line, which is to say that the probe 21 moves parallel to the Y axis away from the center line to trace the left tooth face L. The locus of the probe 21 at this time describes a true involute curve.

A comparison of this invention and the base circle method shows that the amount of movement Y of the probe 2 along the Y axis in this invention is smaller than the amount movement Y′ along the Y axis in the base circle method. This is because in the base circle method, measurement of the right tooth face R is performed within the range of Y′-R, measurement of the left tooth face L is performed in the range of Y′-L, and a range within which measurement is not performed further occurs between Y′-R and Y′-L, while in this invention, the right tooth face R and left tooth face L can be measured within the amount of movement Y along the Y axis.

In addition, the amount of θ axis rotation θ of the gear G around the gear axis in this invention is smaller than the amount of θ axis rotation θ′ in the base circle method.

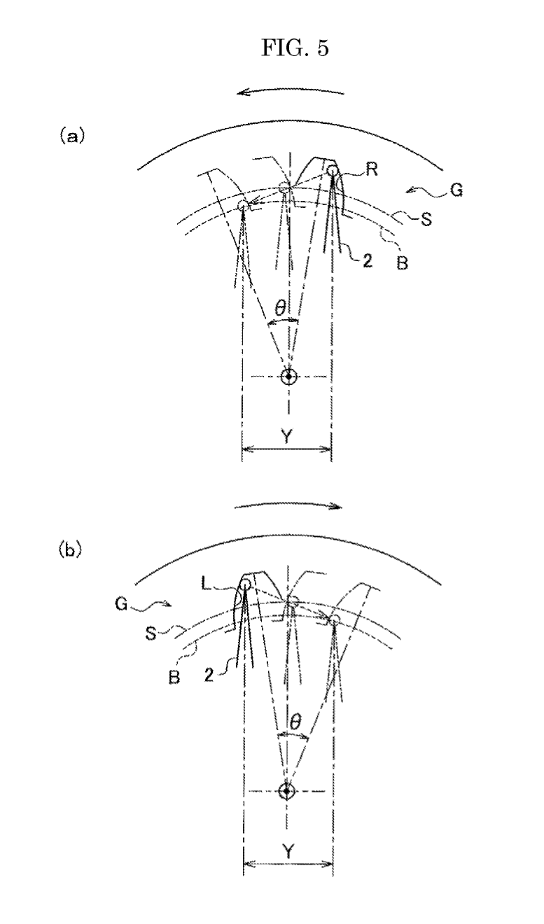

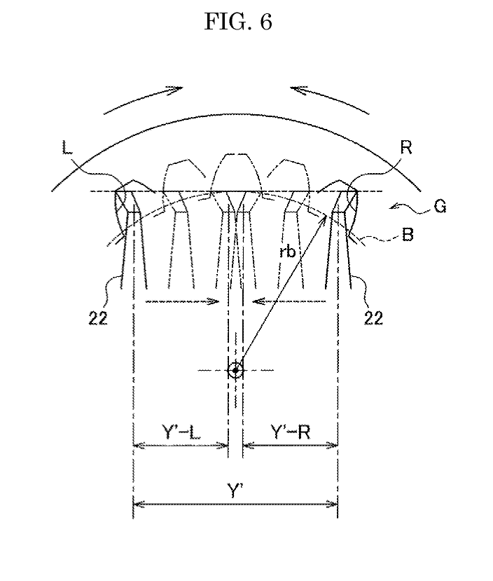

Measurement of an inner gear by the invention tooth profile measuring method will now be explained. FIG. 5 is a set of views illustrating the measurement principle of the method of measuring gear tooth profile of this invention. FIG. 5(a) is a view showing the case of measuring the right tooth face of an inner gear, and FIG. 5(b) is a view showing the case of measuring the left tooth face of the inner gear. FIG. 6 is a view illustrating the principle of gear tooth profile measurement utilizing the base circle method, showing the case of measuring an inner gear. In the figures, B indicates the base circle and S indicates the reference circle.

As shown in FIG. 5(a), when the right tooth face R of an inner gear G is measured by the invention method of measuring gear tooth profile, the probe 2 located on the line of action indicated by an arrow is moved from the dedendum of the right tooth face R indicated by a solid line synchronously with counterclockwise rotation of the outer gear G, as shown by a two-dot chain line, along the line of action indicated by the arrow toward the addendum side to trace the right tooth face R. The locus of the probe 2 at this time describes a true involute curve.

As shown in FIG. 5(b), when the left tooth face L of an inner gear G is measured by the invention method of measuring gear tooth profile, the probe 2 located on the line of action indicated by an arrow is moved from the dedendum of the left tooth face L indicated by a solid line synchronously with clockwise rotation of the outer gear G, as shown by a two-dot chain line, along the line of action indicated by the arrow toward the addendum side to trace the left tooth face L. The locus of the probe 2 at this time describes a true involute curve.

On the other hand, as shown in FIG. 6, when the right tooth face R of an inner gear G is measured by the base circle tooth profile measuring method, a special probe 22 located on the right tooth face R as indicated by a solid line is moved from the point of intersection with a tangent to the base circle B synchronously with counterclockwise rotation of the inner gear G, as shown by a two-dot chain line, tangentially to the base circle B as indicated by a dotted line, which is to say that the special probe 22 moves parallel to the Y axis toward the center line to trace the right tooth face R. The locus of the special probe 22 at this time describes a true involute curve.

As shown in FIG. 6, when the left tooth face L of an inner gear G is measured by the base circle tooth profile measuring method, the special probe 22 located on the left tooth face L as indicated by a solid line is moved from the point of intersection with a tangent to the base circle B synchronously with clockwise rotation of the inner gear G, as shown by a two-dot chain line, tangentially to the base circle B as indicated by a dotted line, which is to say that the special probe 22 moves parallel to the Y axis toward the center line to trace the left tooth face L. The locus of the special probe 22 at this time describes a true involute curve.

A comparison of this invention and the base circle method shows that the amount of movement Y of the probe 2 along the Y axis in this invention is smaller than the amount movement Y′ along the Y axis in the base circle method. This is because in the base circle method, measurement of the right tooth face R is performed within the range of Y′-R and measurement of the left tooth face L is performed in the range of Y′-L, while in this invention, the right tooth face R and left tooth face L can be measured within the amount of movement Y along the Y axis.

Thus in this invention, not only is the amount of movement along the Y axis small, but the right tooth face R and left tooth face L can be measured within substantially the same range on the Y axis. No special probe 22 like that of the base circle method is required.

While this invention was explained with reference to an embodiment in the foregoing, it is not limited to the particulars of this embodiment. For example, the probe 2 of this invention can move in a different direction from what was explained with regard to FIGS. 2, 3 and 5, provided that it moves along the line of action.

### EXPLANATION OF SYMBOLS

51 Tooth profile measuring machine
2 Probe
G Test gear
B Base circle
S Reference circle

1. A method of measuring involute gear tooth profile wherein a probe is held in contact with and moved along a tooth face of a test gear to measure tooth profile in a plane perpendicular to a gear axis, which method comprises:
performing measurement during simultaneous θ axis control for rotating said test gear around said gear axis, X axis control for reciprocating said probe toward and away from said gear axis, and Y axis control for reciprocating said probe perpendicular to said X axis.

2. A method of measuring involute gear tooth profile according to claim 1, wherein measurement is performed while moving said probe along a line of action.
